(19) United States
(12) Patent Application Publication
(10) Pub. No.: US 2002/0078754 A1
(43) Pub. Date: Jun. 27, 2002

(54) Pressure gauge device

(76) Inventor: Wan-Baq Chen, Changhua-Hsien (TW)

Correspondence Address: RABIN & CHAMPAGNE, PC, 1101 14TH STREET, NW, SUITE 500, WASHINGTON, DC, 20005, US

(21) Appl. No.: 09/745,242

(22) Filed: Dec. 22, 2000

(51) Int. Cl. G01L 7/08

(52) U.S. Cl. 73/715

(57) ABSTRACT

A pressure gauge device comprises a gauge; a body including an inlet pipe coupled to an air supply line, an outlet pipe, a hole threadedly secured to the gauge and in communication with the outlet pipe, a control chamber between and in communication with-the inlet pipe and the outlet pipe, the control chamber including a pivot seat; a hose; a connector coupled to the hose; a union for preventing air from leaking; a handle having one end pivotably coupled the pivot seat; a check valve inserted through the control chamber, the check valve including a reduced diameter section at the bottom hole of the control chamber between the bottom and the stem thereof; a sealing means including a hollow gland on the handle for securing the bottom of the check value, an upper seal, and a lower seal; and an elastic means including a large spring biased against the upper seal and a small spring biased against the top of the check valve. Check valve is operable by pressing the handle for opening or closing the air supply line.

### FIELD OF THE INVENTION

The present invention relates to gauges and more particularly to a pressure gauge device with improved convenience.

### BACKGROUND OF THE INVENTION

A conventional pressure gauge device A is shown in FIG. 1. The gauge A is used to measure the pressure of supplying air from an air compressor to the tire of a motor vehicle (e.g., motorcycle, automobile, etc.) In operation, both body A1 of gauge A and handle A3 on body A1 are gripped by hand in order to open check valve B. When check valve B is open, high pressure air from air compressor is fed to tire of the motor vehicle through pipe A2, body A1, hose A4, and adaptor A5. Handle A3 is released for stopping inflating when the pressure measured in gauge A has reached a maximum value. In the case that pressure is larger than normal value, user has to activate a relief value A6 in order to reduce the pressure. However, the previous design suffered from several disadvantages. For example, it typically requires to use both hands to deactivate gauge A for stopping inflating. It is quite inconvenient. Also, it is impossible to adjust or rotate hose A4 once adaptor A5 is coupled to valve of tire of a motor vehicle. Thus it is possible that hose A4 is disengaged from adaptor A5 when user moves or rotates hose A4 because user is not aware of above fact. Moreover, one adaptor A5 is applicable only to valve of tire of one type of motor vehicle (e.g., motorcycle). Hence, another type of adaptor A5 is required for being adapted to valve of tire of another type of motor vehicle (e.g., car). Such replacement is bothersome.

Thus, it is desirable to-provide a new and improved pressure gauge device in order to overcome the above drawbacks prior art.

### SUMMARY OF THE INVENTION

It is an object of the present invention to provide a pressure gauge device comprising a gauge; a body including an inlet pipe, an outlet pipe, an inlet fitting coupled to an air supply line, an outlet fitting, a hole threadedly secured to the gauge and in communication with the outlet pipe, a control chamber between and in communication with the inlet pipe and the outlet pipe, the control chamber including a top hole stopped by a fastener, a bottom hole, and a shoulder, and a pivot seat, a hose; a connector; a union; a handle having one end pivotably coupled the pivot seat; a check valve inserted through the control chamber, the check valve including a stem, a bottom, a reduced diameter section at the bottom hole of the control chamber between the bottom and the stem thereof, and a top; a sealing means including a hollow gland on the handle for securing, the bottom of the check-value, an upper seal around the top of the stem, and a lower seal around the bottom of the stem-wherein the diameter of the lower seal is larger than that of the shoulder for being limited against further movement downwardly; and an elastic means including a large spring and a small spring on the top of the check valve wherein the small spring is biased against the top of the check valve and the large spring is biased against the upper seal; wherein the check valve is operable by pressing the handle for opening or closing the air supply line.

In one aspect of the present invention, the union comprises a reduced orifice and the connector comprises a fitting pivotably coupled to the reduced orifice, an annular recess on the fitting, a ring put on the annular recess, a first pipe sleeved on the hose, a non-slip member put on the first pipe and the hose, and a wavy tube shaped to conform to the non-slip member put on the non-slip member for securing the connector and the hose together.

In another aspect of the present invention, the hose comprises a threaded fitting capable of being secured to one of a variety of adaptors.

The above and other objects, features and advantages of the present invention will become apparent from the following detailed description taken with the accompanying drawings.

### BRIEF DESCRIPTION OF THE DRAWINGS

FIG. 1 is a perspective view of a conventional pressure gauge device;

FIG. 2 is an exploded view of a pressure gauge device according to the invention;

FIG. 2A is an exploded view illustrating a variety of adaptors capable of coupling to hose shown in FIG. 2;

FIG. 3 is a perspective view of the FIG. 2 pressure gauge device;

FIG. 4A is a cross sectional view of the main part of the FIG. 2 pressure gauge device;

FIG. 4B is a cross- sectional view showing the coupling of hose with connector shown in FIG. 2;

FIG. 5 is a cross sectional view showing the pressure relief operation of the invention; and

FIG. 6 is a view similar to FIG. 5 showing the air supplying operation of the invention.

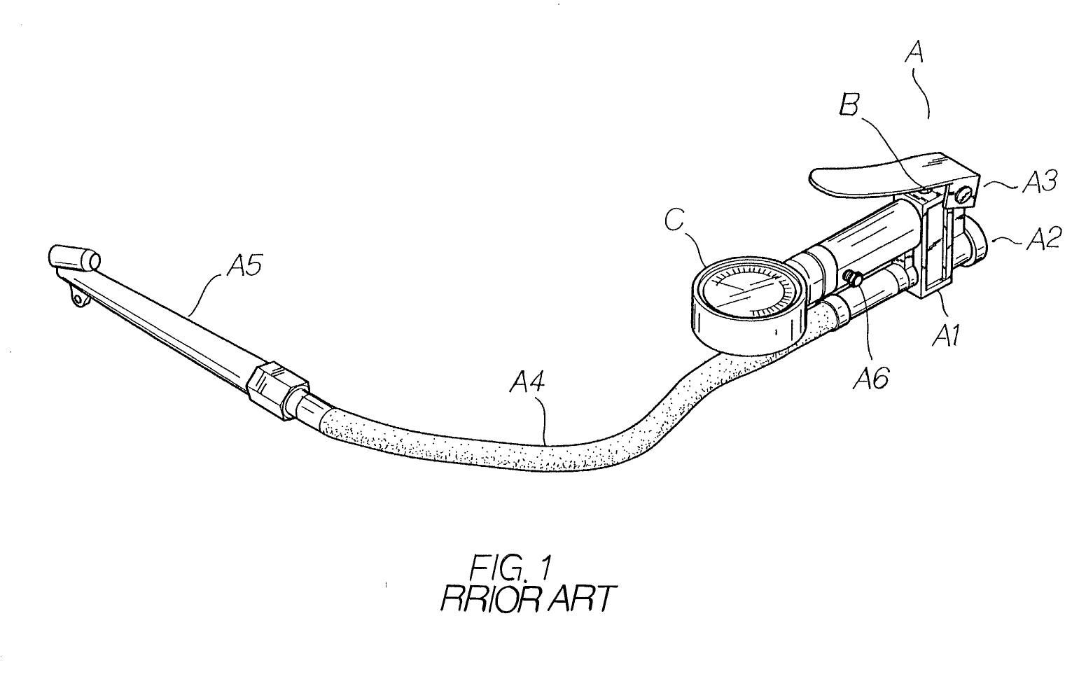

### DETAILED DESCRIPTION OF PREFERRED EMBODIMENTS

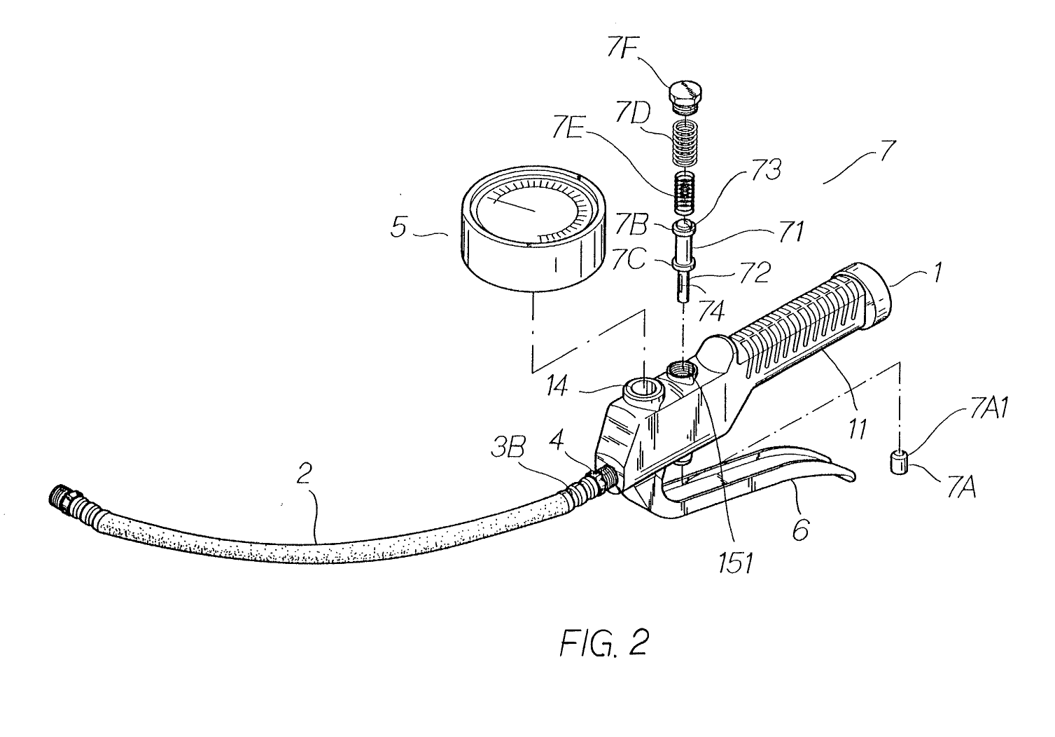

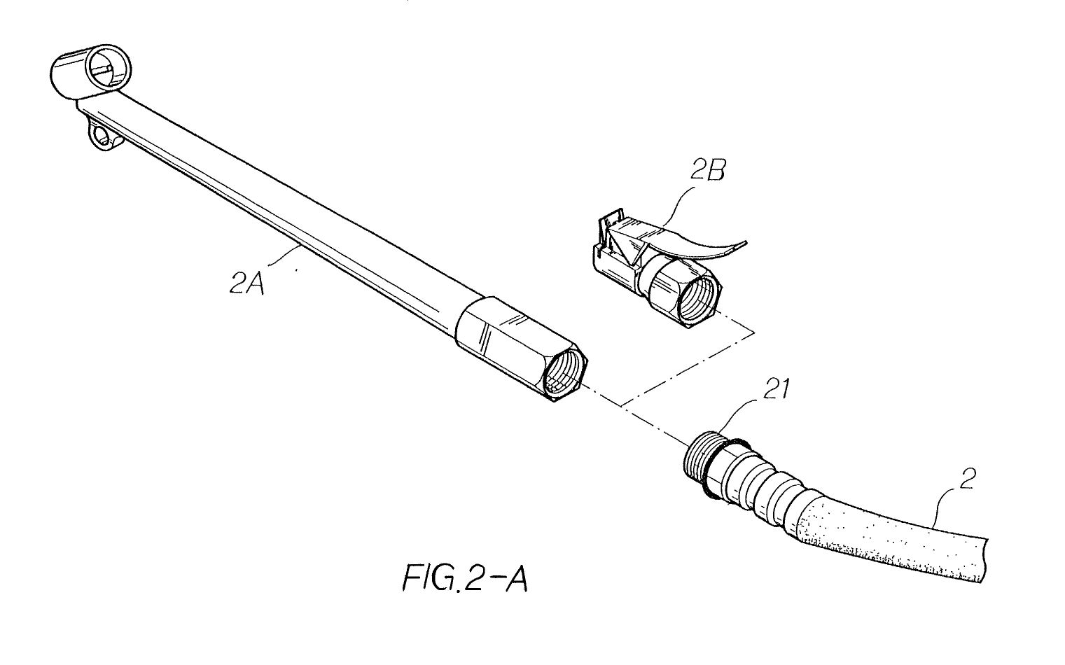

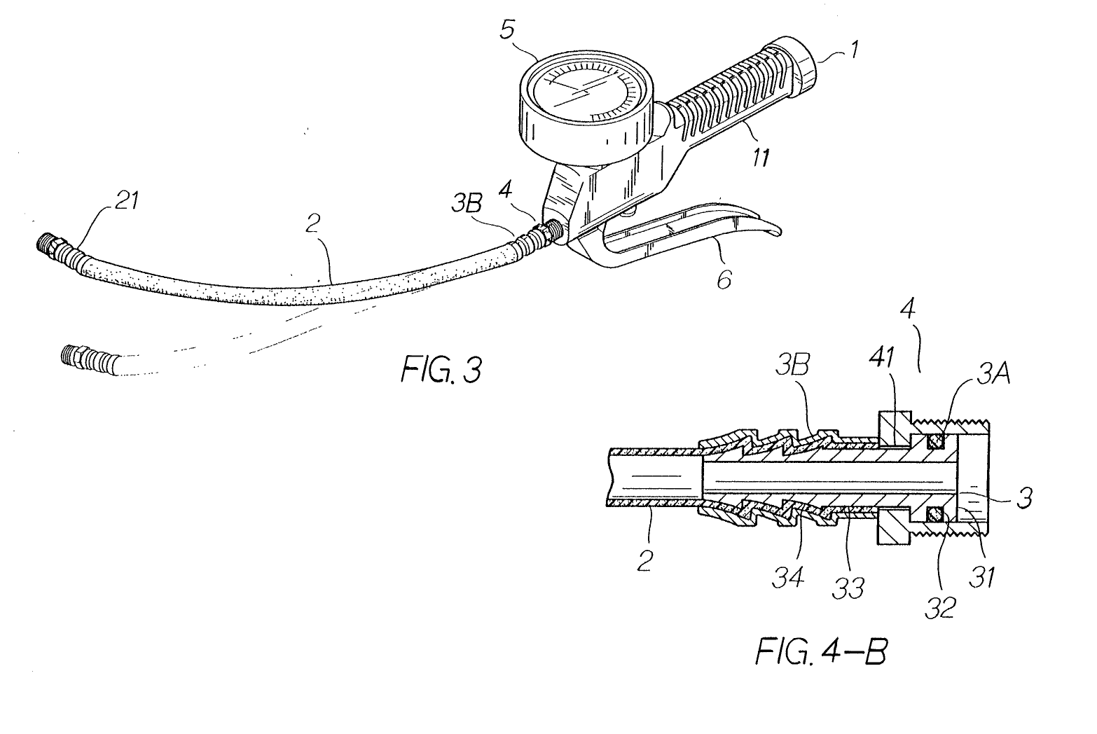

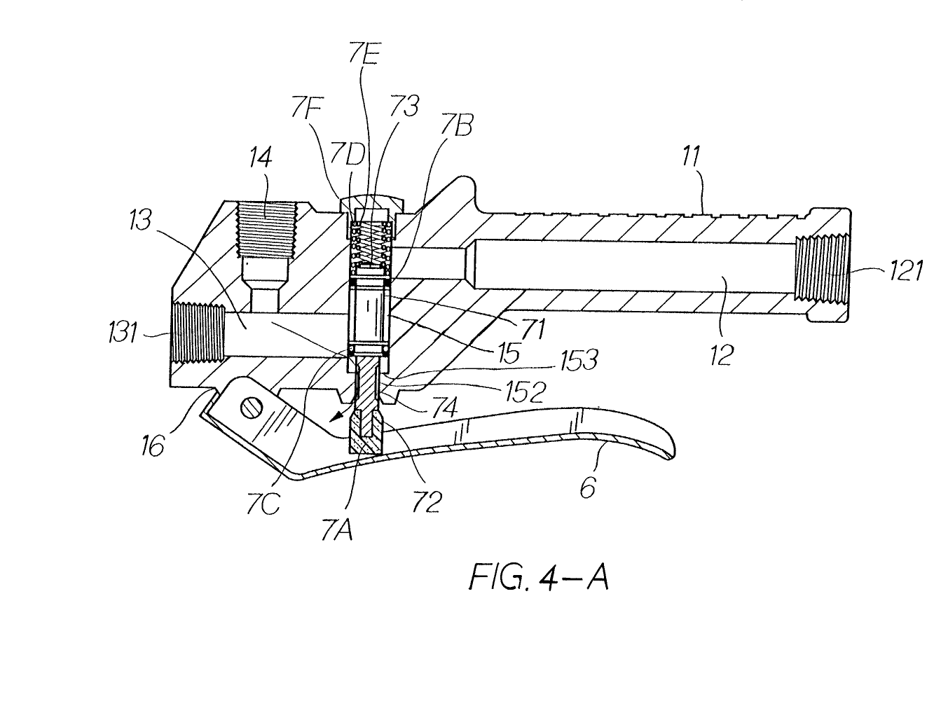

Referring to FIGS. 2 to 4B, a pressure gauge device 1 constructed in accordance with the invention comprising a body 11, a hose 2, a connector 3, a union 4, a gauge 5, a handle 6, and a check valve 7. Each of above component is detailed below.

Body 11 includes an inlet pipe 12, an outlet pipe 13, an inlet fitting 121 coupled to a supply line of air compressor (not shown), an outlet fitting 131 coupled to a threaded fitting 21 of hose 2, a hole 14 threadedly secured to gauge 5, a control chamber 15, and a pivot seat 16 pivotably coupled to one end of handle 6. Hose 2 includes threaded fitting 21 and a large adaptor 2A (or small adaptor 2B) coupled to the threaded fitting 21 for being adapted to various valves of tires of motor vehicles (e.g., motorcycles, cars, etc.). This eliminates the necessity of replacing adaptor when inflating a variety of motor vehicles as experienced in prior art. Connector 3 is rotatably coupled to union 4. In detail, fitting 31 of connector 3 is pivotably coupled to a reduced orifice 41 of union 4. Further, a ring 3A is put on an annular recess 32 on fitting 31 for preventing air from leaking at the joint of connector 3 and union 4. A short pipe 33 is projected from connector 3 for sleeving on hose 2. A non-slip member 34 is put on the short pipe 33 and hose 2. Further, a short wavy tube 3B shaped to conform to the non-slip member 34 is put on it for securing them together. Hole 14 is in communication between outlet pipe 13 and the gauge 5 such that user may understand the current pressure of supplying air from the display of gauge 5. Control chamber 15 is located between and in communication with inlet pipe 12 and outlet pipe 13. Check valve 7 is inserted through control chamber 15. The bottom 72 of check valve 7 is fixed in a hollow gland 7A which is secured to handle 6. A reduced diameter section 74 is formed at bottom hole 152 between bottom 72 and stem 71 of check valve 7. An upper seal 7B and a lower seal 7C are formed around the top and bottom of stem 71. The diameter of lower seal 7C is larger than that of shoulder 153 and thus is limited against further movement downwardly. Large and small springs 7D and 7E are provided on the top 73 of check valve 7 wherein small spring 7E is biased-against top 73 of check valve 7 and large spring 7D is biased against upper seal 7B. The provision of large and small springs can effect a smooth up and down movement of check valve 7. Further, a thumb screw 7F is secured to a top hole 151 of control chamber 15.

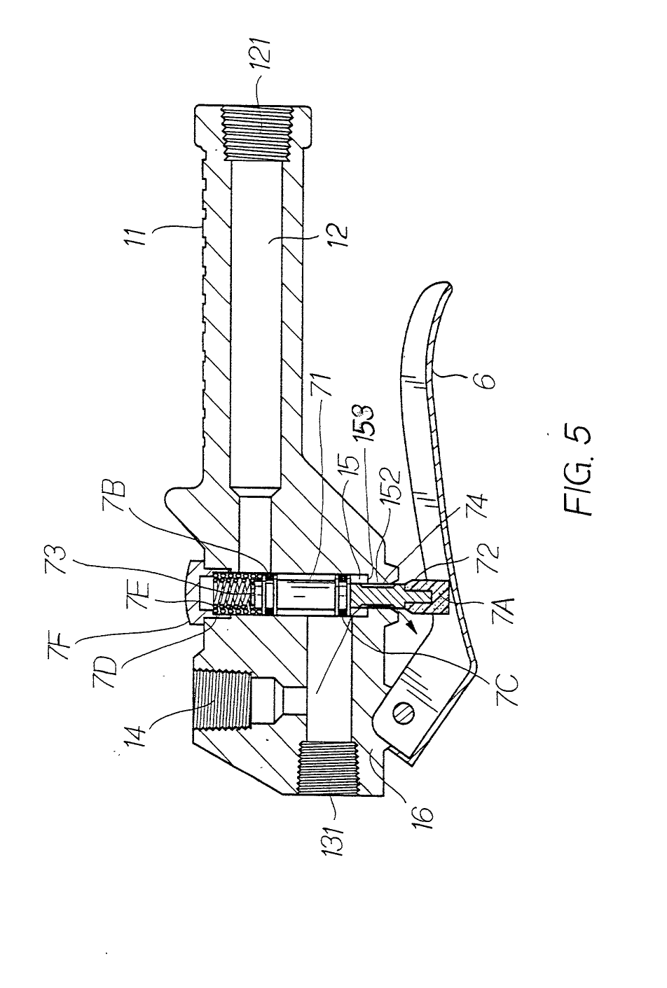

Referring to FIG. 5, in operation, both body 11 and handle 6 on body 11 are gripped by hand. Then slightly press handle 6 to cause check valve 7 to move up toward top hole 151 of control chamber 15. Lower seal 7C is then lifted from shoulder 153 to move to a place in contact with outlet pipe 13. At the same time, bottom hole 152 of control chamber 15 is in communication with outlet pipe 13. The bottom hole 152 of control chamber 15 is not blocked by gland 7A. The passage between inlet pipe 12 and control chamber 15 is blocked by upper seal 7B, thus preventing high pressure air from entering outlet pipe 13. Instead, the high pressure of tire of motor vehicle is fed through fitting 21, hose 2, outlet pipe 13, and a gap between bottom hole 152 of control chamber 15 and the reduced diameter section 74 to the atmosphere. This effects a pressure release of the tire of motor vehicle.

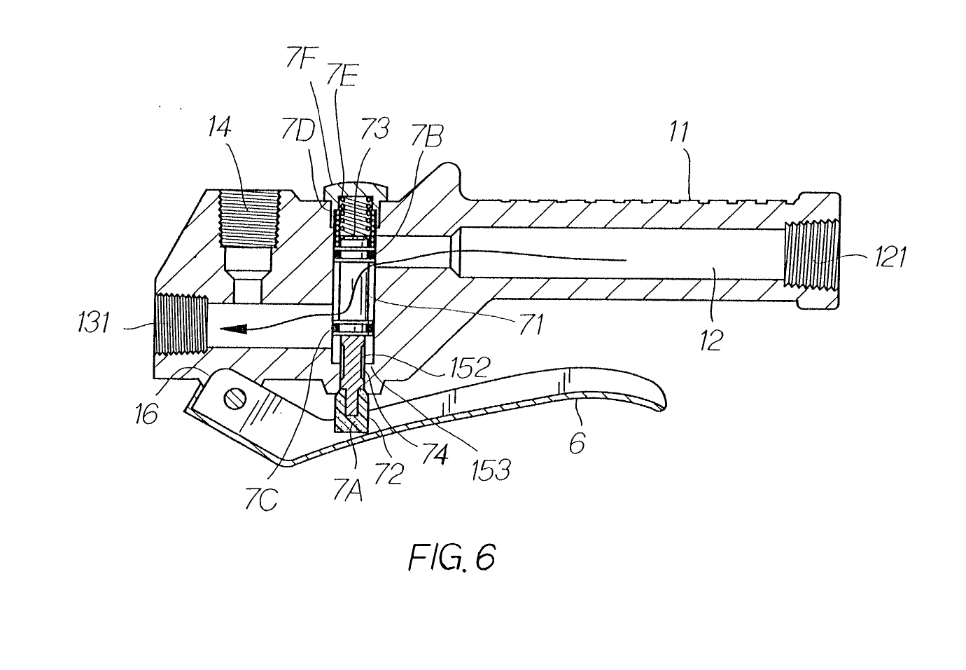

Referring to FIG. 6, user may continue to press handle 6 to cause check valve 7 to further move up toward top hole 151 of control chamber 15. The passage between inlet pipe 12 and control chamber 15 is not blocked by upper seal 7B. Further, the bottom hole 152 of control chamber 15 is blocked-by gland 7A, thus preventing high pressure air from passing therethrough. As a result, the high pressure air of air compressor, is fed through inlet fitting 121, inlet-pipe 12, control chamber 15, outlet pipe 13, hose 2, fitting 21, and adaptor into tire of motor vehicle. This effects an air charge of the tire of motor vehicle.

In brief, the pressure gauge release and air charge of a motor vehicle is done by simply manipulating handle 6. Thus it is quick and convenient.

While the invention has been described by means of specific embodiments, numerous modifications and variations could be made thereto by those -skilled in the art without departing from the scope and spirit of the invention set forth in the claims.

What is claimed is:

1. A pressure gauge device comprising:
a gauge;
a body including an inlet, pipe, an outlet pipe, an inlet fitting coupled to an air supply line, an outlet fitting, a hole threadedly secured to said gauge and in communication with said outlet pipe, a control chamber between and in communication with said inlet pipe and said outlet pipe, said control chamber including a top hole stopped by a fastener, a bottom hole, and a shoulder, and a pivot seat;
a hose;
a connector;
a union;
a handle having one end pivotably coupled said pivot seat;
a check valve inserted through said control chamber, said check valve including a stem, a bottom, a reduced diameter section at said bottom hole of said control chamber between said bottom and said stem thereof, and a top;
a sealing means including a hollow gland on said handle for securing said bottom of said check value, an upper seal around said top of said stem, and a lower seal around said bottom of said stem wherein said diameter of said lower seal is larger than that of said shoulder for being limited against further movement downwardly; and
an elastic means including a large spring and a small spring on said top of said check valve wherein said small spring is biased against said top of said check valve and said large spring is biased against said upper seal;
wherein said check valve is operable by pressing said handle for opening or closing said air supply line.

2. The pressure gauge device of claim 1, wherein said union comprises a reduced orifice and said connector comprises a fitting pivotably coupled to said reduced orifice, an annular recess on said fitting, a ring put on said annular recess, a first pipe sleeved on said hose, a non-slip member put on said first pipe and said hose, and a wavy tube shaped to conform to said non-slip member put on said non-slip member for securing said connector and said hose together.

3. The pressure gauge device of claim 1, wherein said hose comprises a threaded fitting capable of being secured to one of a variety of adaptors.
